(19) United States
(12) Patent Application Publication
(10) Pub. No.: US 2017/0274728 A1
(43) Pub. Date: Sep. 28, 2017

(54) MOTOR-DRIVEN COMPRESSOR AND COOLING SYSTEM

(71) Applicants: KABUSHIKI KAISHA TOYOTA JIDOSHOKKI, Kariya-shi (JP); TOYOTA JIDOSHA KABUSHIKI KAISHA, Toyota-shi (JP)

(72) Inventors: Junya SUZUKI, Kariya-shi (JP); Rei MORINAGA, Susono-shi (JP); Hideaki MIZUNO, Owariasahi-shi (JP)

(73) Assignees: KABUSHIKI KAISHA TOYOTA JIDOSHOKKI, Kariya-shi (JP); TOYOTA JIDOSHA KABUSHIKI KAISHA, Toyota-shi (JP)

(21) Appl. No.: 15/463,000

(22) Filed: Mar. 20, 2017

(30) Foreign Application Priority Data
Mar. 23, 2016 (JP) 2016-058719

(51) Int. Cl. B60H 1/00; F04C 29/04; B60L 11/18; H01M 8/04111; F04C 29/00; F04C 27/00; B60H 1/32; F04C 18/02; F04C 18/12

(52) U.S. Cl. CPC B60H 1/00271; F04C 18/0215; F04C 29/045; B60L 11/1892; F04C 18/126; F04C 29/0085; F04C 27/005; B60H 1/3222; B60H 1/3205; H01M 8/04111; F04C 2240/40; F04C 2210/26; B60H 2001/3292; B60H 2001/3289; B60H 2001/00307; H02P 27/06

(57) ABSTRACT

A motor-driven compressor is installed in a fuel cell vehicle to supply air to a fuel cell. The motor driven compressor includes a rotation shaft, an electric motor, a compression unit that compresses air, a housing that includes a motor chamber and a compression chamber, and a seal member that restricts a flow of a fluid between the motor chamber and the compression chamber. The housing includes an inlet and an outlet. The inlet draws, into the motor chamber, the air-conditioning refrigerant that has passed through the evaporator but has not reached the air-conditioning compressor as a low-temperature refrigerant. The outlet discharges the low-temperature refrigerant, which is drawn from the inlet into the motor chamber, out of the motor chamber.

### BACKGROUND OF THE INVENTION

The present invention relates to a motor-driven compressor and a cooling system that are installed in a fuel cell vehicle.

A fuel cell vehicle known in the prior art includes a travel motor. The travel motor is powered by a fuel cell and driven when the fuel cell vehicle travels (for example, refer to Japanese Laid-Open Patent Publication No. 2015-159005). A fuel cell installed in a fuel cell vehicle generates power through a chemical reaction of hydrogen, which is supplied from a hydrogen tank, with oxygen, which is included in the air. The vehicle includes a motor-driven compressor, which draws in and compresses air from outside the vehicle. The compressed air is discharged from the motor-driven compressor and supplied to the fuel cell. The motor-driven compressor includes, for example, a rotation shaft, an electric motor, which rotates the rotation shaft, a compression unit, which is rotated to compress air when the rotation shaft is rotated, and a housing, which accommodates the rotation shaft, the electric motor, and the compression unit.

The electric motor includes a rotor, which is fixed to the rotation shaft, and a stator, which is fixed to the housing. The stator includes a stator core and coils, which are wound around the stator core.

In the fuel cell vehicle, the current flowing to the travel motor is controlled in accordance with the accelerator position (open degree of throttle valve). The fuel cell, which powers the travel motor, generates power in accordance with the accelerator position. To generate power with the fuel cell, the motor-driven compressor supplies air to the fuel cell at a flow rate corresponding to the accelerator position.

There is a demand for a motor-driven compressor installed in a fuel cell vehicle that improves the responsiveness to a change in the accelerator position. More specifically, there is a demand that, when the accelerator position is changed, the motor-driven compressor immediately supply air to the fuel cell at a flow rate corresponding to the changed accelerator position. To improve the responsiveness of the motor-driven compressor, the output of the electric motor, which rotates the rotation shaft, may be increased. This will increase the current flowing to the coil and generate more heat in the electric motor.

### SUMMARY OF THE INVENTION

It is an object of the present invention to provide a motor-driven compressor and a cooling system that are capable of cooling an electric motor.

To achieve the above object, a motor-driven compressor is installed in a fuel cell vehicle to supply air to a fuel cell. The fuel cell vehicle includes a travel motor, the fuel cell that powers the travel motor, and an air conditioner including an evaporator and a motor-driven air-conditioning compressor that compresses an air-conditioning refrigerant. The motor driven compressor includes a rotation shaft, an electric motor that rotates the rotation shaft, a compression unit rotated to compress air when the rotation shaft is rotated, a housing that includes a motor chamber that accommodates the electric motor and a compression chamber that accommodates the compression unit, and a seal member that restricts a flow of a fluid between the motor chamber and the compression chamber. The housing includes an inlet and an outlet. The inlet draws, into the motor chamber, the air-conditioning refrigerant that has passed through the evaporator but has not reached the air-conditioning compressor as a low-temperature refrigerant. The outlet discharges the low-temperature refrigerant, which is drawn from the inlet into the motor chamber, out of the motor chamber.

This structure restricts the flow of a fluid between the motor chamber and the compression chamber. Thus, different kinds of fluids may flow to the motor chamber and the compression chamber. The low-temperature refrigerant, which is the air-conditioning refrigerant that has passed through the evaporator but has not reached the air-conditioning compressor, flows through the motor chamber from the inlet toward the outlet. Thus, heat is directly exchanged between the electric motor and the low-temperature refrigerant. This cools the electric motor.

Preferably, the housing further includes a partition wall defining the motor chamber and a water jacket that at least partially covers an outer side of the partition wall to define a passage through which a coolant flows between the partition wall and the water jacket.

In this structure, when the coolant flows to the passage, heat is exchanged between the partition wall and the coolant. Since the partition wall defining the motor chamber exchanges heat with the electric motor, heat is indirectly exchanged between the coolant and the electric motor through the partition wall. Therefore, the electric motor is cooled when the low-temperature refrigerant flows to the motor chamber and when the coolant flows to the passage.

Preferably, the housing includes a separation wall that separates the motor chamber and the compression chamber and includes a through hole through which the rotation shaft is inserted.

In this structure, even when the motor chamber and the compression chamber are separated by a separation wall including a through hole, the seal member restricts the flow of fluids through the through hole.

To achieve the above object, a cooling system is installed in a fuel cell vehicle to cool an electric motor arranged in a motor-driven compressor. The fuel cell vehicle includes a travel motor, a fuel cell that powers the travel motor, an air conditioner including an evaporator and a motor-driven air-conditioning compressor that compresses an air-conditioning refrigerant, and the motor-driven compressor that supplies air to the fuel cell. The cooling system includes a rotation shaft, the electric motor that rotates the rotation shaft, a compression unit rotated to compress air when the rotation shaft is rotated, a housing that includes a motor chamber that accommodates the electric motor and a compression chamber that accommodates the compression unit, and a seal member that restricts a flow of a fluid between the motor chamber and the compression chamber. The housing includes an inlet and an outlet. The inlet draws, into the motor chamber, the air-conditioning refrigerant that has passed through the evaporator but has not reached the air-conditioning compressor as a low-temperature refrigerant. The outlet discharges the low-temperature refrigerant, which is drawn from the inlet into the motor chamber, out of the motor chamber. The cooling system further includes an inlet pipe that connects the evaporator and the inlet, an outlet pipe that connects the outlet and the air-conditioning compressor, and a switching portion that switches between a state allowing the low-temperature refrigerant to flow to the inlet through the inlet pipe and a state prohibiting the low-temperature refrigerant from flowing to the inlet through the inlet pipe.

As described above, the electric motor is cooled when the low-temperature refrigerant flows to the motor chamber. However, to obtain the low-temperature refrigerant, the air-conditioning compressor needs to be driven. Driving of the air-conditioning compressor consumes power. If the low-temperature refrigerant is constantly sent to the motor chamber regardless of the amount of heat generated in the electric motor, a large amount of power is consumed.

In this regard, in the above structure, the switching portion switches between the states allowing and prohibiting the flow of the low-temperature refrigerant to the motor chamber. Thus, the air-conditioning compressor does not constantly have to be driven to obtain the low-temperature refrigerant. This reduces power consumption.

Preferably, the electric motor includes a stator core and a coil wound around the stator core. The cooling system further includes a control portion that controls the switching portion so that the low-temperature refrigerant flows to the inlet through the inlet pipe when a condition in which a temperature of the coil tends to increase is satisfied. The condition is determined based on at least one of a current flowing to the coil, the temperature of the coil, and a traveling state of the fuel cell vehicle.

In this configuration, the air-conditioning compressor is driven only when the condition in which the temperature of the coil tends to increase is satisfied. This reduces power consumption.

Preferably, the condition includes at least one of a current condition and a temperature condition. The current condition is satisfied when the current flowing to the coil is greater than a predetermined current threshold value. The temperature condition is satisfied when the temperature of the coil is greater than a predetermined temperature threshold value.

In this configuration, the low-temperature refrigerant flows to the motor chamber only when at least one of the current condition and the temperature condition is satisfied. Thus, when the current flowing to the coil is less than or equal to the current threshold value or when the temperature of the coil is less than or equal to the temperature threshold value, the air-conditioning compressor does not have to be driven to obtain the low-temperature refrigerant. This reduces power consumption.

Preferably, the housing further includes a partition wall defining the motor chamber and a water jacket that at least partially covers an outer side of the partition wall to define a passage through which a coolant flows between the partition wall and the water jacket. The cooling system further includes a passage connection pipe that connects the passage and a radiator installed in the fuel cell vehicle and a coolant flow switching portion that switches between a state allowing the coolant to flow to the passage through the passage connection pipe and a state prohibiting the coolant from flowing to the passage through the passage connection pipe.

This structure switches the states allowing and prohibiting the flow of the coolant to the passage. Accordingly, whether or not to cool the electric motor using the coolant may be determined as necessary.

Preferably, the electric motor includes a stator core and a coil wound around the stator core. The cooling system further includes a coolant control portion configured to control the coolant flow switching portion so that the coolant flows to the passage through the passage connection pipe when at least one of a coolant flow current condition and a coolant flow temperature condition is satisfied. The coolant flow current condition is satisfied when a current flowing to the coil is less than or equal to a predetermined coolant flow current threshold value. The coolant flow temperature condition is satisfied when a temperature of the coil is less than or equal to a predetermined coolant flow temperature threshold value.

In this configuration, whether or not to cool the electric motor using the coolant may be determined in accordance with the amount of heat generated in the electric motor.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic cross-sectional view showing one embodiment of a motor-driven compressor according to the present invention;

FIG. 2 is a circuit diagram showing the electrical configuration of an inverter; and

FIG. 3 is a schematic diagram of a fuel cell vehicle in which the motor-driven compressor of FIG. 1 and a cooling system are installed.

### DETAILED DESCRIPTION OF THE PREFERRED EMBODIMENTS

One embodiment of a motor-driven compressor and a cooling system will now be described. The motor-driven compressor is installed in a fuel cell vehicle to supply air to a fuel cell. The cooling system is installed in the fuel cell vehicle to cool the motor-driven compressor. The motor-driven compressor will be described first.

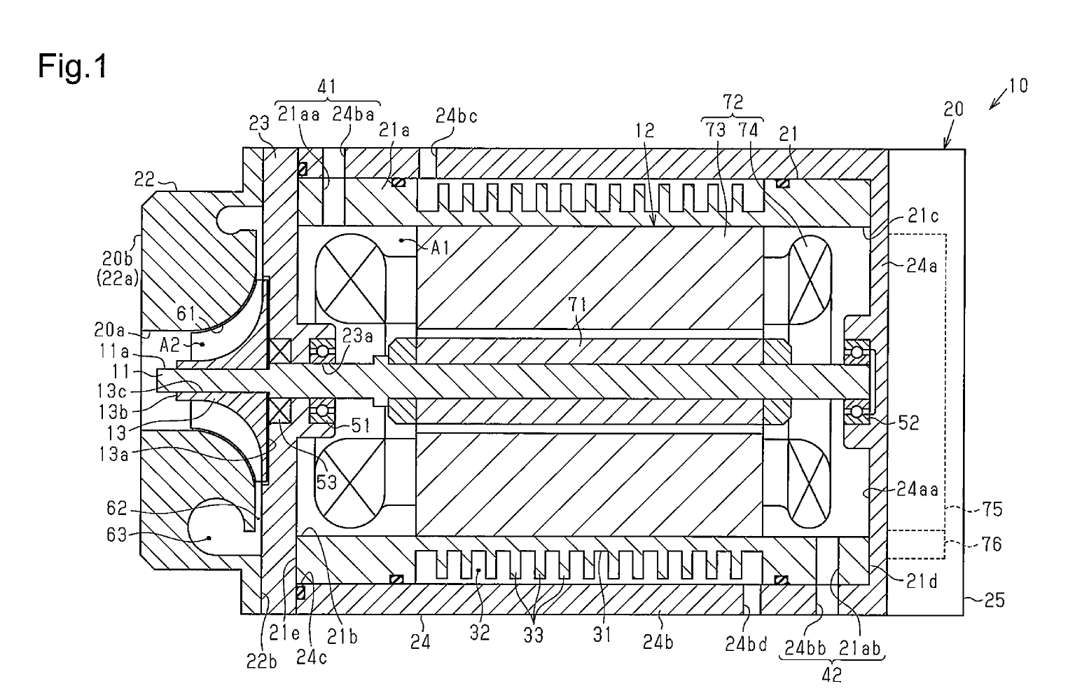

As shown in FIG. 1, a motor-driven compressor 10 includes a rotation shaft 11, an electric motor 12, which is coupled to the rotation shaft 11 to rotate the rotation shaft 11, and an impeller 13, which is coupled to the rotation shaft 11. When the rotation shaft 11 is rotated, the impeller 13 is rotated to compress air.

The motor-driven compressor 10 includes a housing 20, which defines a shell of the motor-driven compressor 10 and accommodates the rotation shaft 11, the electric motor 12, and the impeller 13. The housing 20 is tubular (more specifically, cylindrical tube-shaped) as a whole.

The housing 20 includes a motor housing 21, which accommodates the electric motor 12, a compressor housing 22, which includes an air suction port 20a that draws air in, and a separation wall 23, which is located between the motor housing 21 and the compressor housing 22. The air suction port 20a is arranged in a first axial end surface 20b of the housing 20.

The motor housing 21, which is tubular (more specifically, cylindrical tube-shaped) as a whole, has two opposite ends that are open in an axial direction of the motor housing 21. Thus, the motor housing 21 includes, namely, a tubular side wall 21a and openings 21b, 21c, which are located at opposite axial ends of the motor housing 21.

A first wall through hole 21aa and a second wall through hole 21ab extend through the side wall 21a of the motor housing 21 in a radial direction. The first wall through hole 21aa and the second wall through hole 21ab are separated from each other in the axial direction of the motor housing 21. The first wall through hole 21aa is located closer to the first opening 21b. The second wall through hole 21ab is located closer to the second opening 21c. The first wall through hole 21aa and the second wall through hole 21ab are located at different positions in a circumferential direction of the side wall 21a. In the present embodiment, the first wall through hole 21aa and the second wall through hole 21ab are separated by 180 degrees in the circumferential direction.

The housing 20 includes a water jacket 24, which covers the motor housing 21. The water jacket 24, which is cylindrical tube-shaped as a whole, includes a jacket end wall 24a, which closes the second opening 21c, and a jacket side wall 24b, which covers the side wall 21a of the motor housing 21 from a radially outer side. The water jacket 24 includes an open jacket end 24c. The open jacket end 24c and the jacket end wall 24a are located at opposite sides of the water jacket 24 in the axial direction.

A first jacket through hole 24ba and a second jacket through hole 24bb extend through the jacket side wall 24b in the radial direction. The first jacket through hole 24ba and the second jacket through hole 24bb are separated from each other in the axial direction of the water jacket 24. The first jacket through hole 24ba is located closer to the open jacket end 24c. The second jacket through hole 24bb is located closer to the jacket end wall 24a. The distance between the first jacket through hole 24ba and the second jacket through hole 24bb in the axial direction of the water jacket 24 is the same as that between the first wall through hole 21aa and the second wall through hole 21ab in the axial direction of the motor housing 21. The first jacket through hole 24ba and the second jacket through hole 24bb are located at different positions in a circumferential direction of the jacket side wall 24b. In the present embodiment, the first jacket through hole 24ba and the second jacket through hole 24bb are separated by 180 degrees in the circumferential direction.

Additionally, a third jacket through hole 24bc and a fourth jacket through hole 24bd extend through the jacket side wall 24b in the radial direction. The third jacket through hole 24bc is located closer to a central position than the first jacket through hole 24ba in the axial direction of the water jacket 24. The fourth jacket through hole 24bd is located closer to the central position than the second jacket through hole 24bb in the axial direction of the water jacket 24. The third jacket through hole 24bc and the fourth jacket through hole 24bd are separated by 180 degrees in the circumferential direction.

The water jacket 24 is coupled to the motor housing 21 so that the first wall through hole 21aa is in communication with the first jacket through hole 24ba and so that the second wall through hole 21ab is in communication with the second jacket through hole 24bb. The jacket end wall 24a includes a first surface 24aa that is opposed to the motor housing 21. The motor housing 21 includes two axial end surfaces 21d, 21e. The first end surface 21d is closer to the second opening 21c. The first surface 24aa of the jacket end wall 24a is in contact with the first end surface 21d of the motor housing 21.

As shown in FIG. 1, the side wall 21a of the motor housing 21 includes a coolant recess 31, which extends radially inward from an outer surface of the side wall 21a. The coolant recess 31 is arranged to avoid the positions of the first wall through hole 21aa and the second wall through hole 21ab. In the present embodiment, the coolant recess 31 is located closer to the central position than the first wall through hole 21aa and the second wall through hole 21ab in the axial direction of the motor housing 21. The coolant recess 31 extends around the entire circumference of the side wall 21a. The coolant recess 31 and the side wall 21a of the motor housing 21 define a cylindrical tube-shaped passage 32, in which coolant flows.

The third jacket through hole 24bc is in communication with the passage 32. The third jacket through hole 24bc functions as a flow inlet that allows the coolant to flow into the passage 32. The fourth jacket through hole 24bd is in communication with the passage 32. The fourth jacket through hole 24bd functions as a flow outlet that allows the coolant to flow out of the passage 32. The third jacket through hole 24bc is located in a first end of the passage 32 in the axial direction. The fourth jacket through hole 24bd is located in a second end of the passage 32 in the axial direction.

The coolant recess 31 includes fins 33. The fins 33 project radially outward from a bottom wall of the coolant recess 31. The fins 33 extend in a circumferential direction of the motor housing 21. In the present embodiment, the fins 33 extend around the entire circumference of the side wall 21a of the motor housing 21. Additionally, the fins 33 are arranged next to one another in the axial direction of the motor housing 21. The fins 33 increase the area of contact between the motor housing 21 and the coolant.

The separation wall 23 is in contact with a second end surface 21e, which is one of the two end surfaces 21d, 21e in the axial direction of the motor housing 21 that is located closer to the first opening 21b. The first opening 21b of the motor housing 21 is closed by the separation wall 23. The side wall 21a of the motor housing 21, the jacket end wall 24a of the water jacket 24, and the separation wall 23 define a motor chamber A1, which accommodates the electric motor 12. The side wall 21a of the motor housing 21, the jacket end wall 24a of the water jacket 24, and the separation wall 23 function as partition walls defining the motor chamber A1.

The first wall through hole 21aa and the first jacket through hole 24ba communicate the inside of the motor chamber A1 to the outside of the motor chamber A1. In the same manner, the second wall through hole 21ab and the second jacket through hole 24bb communicate the inside of the motor chamber A1 to the outside of the motor chamber A1. The first wall through hole 21aa and the first jacket through hole 24ba function as an inlet 41, which draws an air-conditioning refrigerant into the motor chamber A1 from outside the motor chamber A1. The air-conditioning refrigerant will be described later. The second wall through hole 21ab and the second jacket through hole 24bb function as an outlet 42, which discharges the air-conditioning refrigerant out of the motor chamber A1.

The inlet 41 and the outlet 42 have the same positional relationship as the first wall through hole 21aa and the second wall through hole 21ab (first jacket through hole 24ba and second jacket through hole 24bb). The inlet 41 and the outlet 42 are separated from each other in the axial direction of the motor housing 21 by 180 degrees in the circumferential direction of the motor housing 21.

A through hole 23a extends through the separation wall 23 in a thickness-wise direction (axial direction). The through hole 23a has a larger diameter than the rotation shaft 11. The rotation shaft 11 is inserted through the through hole 23a. The rotation shaft 11 is partially located in the compressor housing 22 through the through hole 23a. A first radial bearing 51 is located between a circumferential surface 11a of the rotation shaft 11 and a wall surface defining the through hole 23a to rotationally support the rotation shaft 11.

The jacket end wall 24a includes a second radial bearing 52, which rotationally supports the rotation shaft 11. The rotation shaft 11 is rotationally supported by the two radial bearings 51, 52 on the housing 20. In the present embodiment, each of the two radial bearings 51, 52 is of a contact type and is, for example, a rolling bearing, which may be a ball bearing, or a plain bearing.

As shown in FIG. 1, the compressor housing 22 is tubular and includes a compressor through hole 61, which extends through the compressor housing 22 in the axial direction. The compressor housing 22 includes a first end surface 22a in the axial direction. The first end surface 22a defines the first axial end surface 20b of the housing 20. The compressor through hole 61 functions as the air suction port 20a at a position closer to the first end surface 22a.

The compressor housing 22 includes a second end surface 22b, which is opposite to the first end surface 22a in the axial direction of the compressor housing 22. The compressor housing 22 and the separation wall 23 are coupled with the second end surface 22b of the compressor housing 22 contacting the surface of the separation wall 23 that is opposite to the motor housing 21. In this case, a wall surface of the compressor through hole 61 and the surface of the separation wall 23 that is opposite to the motor housing 21 define a compression chamber A2, which accommodates the impeller 13. More specifically, the compressor through hole 61 functions as the air suction port 20a and also defines the compression chamber A2. The air suction port 20a is in communication with the compression chamber A2.

The separation wall 23, which is located between the motor chamber A1 and the compression chamber A2, separates the motor chamber A1 and the compression chamber A2. A seal member 53 is located between the wall surface of the through hole 23a, which is located in the separation wall 23, and the circumferential surface 11a of the rotation shaft 11. The seal member 53, which is located between the motor chamber A1 and the compression chamber A2, restricts the flow of fluids between the motor chamber A1 and the compression chamber A2 through the through hole 23a. Thus, the motor chamber A1 is not in communication with the compression chamber A2. This allows different kinds of fluids to flow to the motor chamber A1 and the compression chamber A2.

The compressor through hole 61 is substantially shaped as a truncated cone such that the diameter of the compressor through hole 61 is fixed from the air suction port 20a to an intermediate position in the axial direction and gradually increased from the intermediate position toward the separation wall 23. Thus, the compression chamber A2 is substantially shaped as a truncated cone.

The impeller 13, which functions as a compression unit, is tubular and includes a basal surface 13a and a distal surface 13b. The diameter of the impeller 13 is gradually decreased from the basal surface 13a toward the distal surface 13b. The impeller 13 includes an insertion hole 13c, which extends in the axial direction and allows for insertion of the rotation shaft 11. When the portion of the rotation shaft 11 projected into the compressor through hole 61 is inserted through the insertion hole 13c, the impeller 13 is coupled to the rotation shaft 11 so that the impeller 13 is rotated integrally with the rotation shaft 11. Thus, when the rotation shaft 11 is rotated, the impeller 13 is rotated to compress air, which is drawn from the air suction port 20a.

The motor-driven compressor 10 further includes a diffuser flow passage 62 and a discharge chamber 63. The air compressed by the impeller 13 flows into the diffuser flow passage 62. When a fluid passes through the diffuser flow passage 62, the fluid flows into the discharge chamber 63. The diffuser flow passage 62 is located at an outer side of the compression chamber A2 in a radial direction of the rotation shaft 11. The diffuser flow passage 62 is loop-shaped (more specifically, annular) to surround the impeller 13 (and compression chamber A2). The discharge chamber 63 is loop-shaped and located at an outer side of the diffuser flow passage 62 in the radial direction of the rotation shaft 11. The compression chamber A2 is in communication with the discharge chamber 63 through the diffuser flow passage 62. A fluid compressed by the impeller 13 is further compressed by passing through the diffuser flow passage 62 and sent to the discharge chamber 63. The fluid is discharged from the discharge chamber 63.

As shown in FIG. 1, the electric motor 12, which is accommodated in the motor chamber A1, includes a rotor 71 and a stator 72. The rotor 71 is fixed to the rotation shaft 11. The stator 72 is located at an outer side of the rotor 71 in the radial direction of the rotation shaft 11 and fixed to an inner circumferential surface of the side wall 21a of the motor housing 21. The rotation axis of the rotor 71 and the center axis of the stator 72 are aligned with the rotation axis of the rotation shaft 11. The rotor 71 is opposed to the stator 72 in the radial direction of the rotation shaft 11

The stator 72 includes a cylindrical tube-shaped stator core 73 and a coil 74, which is wound around the stator core 73. When current flows to the coil 74, the rotor 71 is rotated integrally with the rotation shaft 11.

The motor-driven compressor 10 includes an inverter 75, which drives the electric motor 12. The inverter 75 is accommodated in the housing 20, more specifically, a cylindrical tube-shaped cover member 25 attached to the jacket end wall 24a. The inverter 75 is electrically connected to the coil 74.

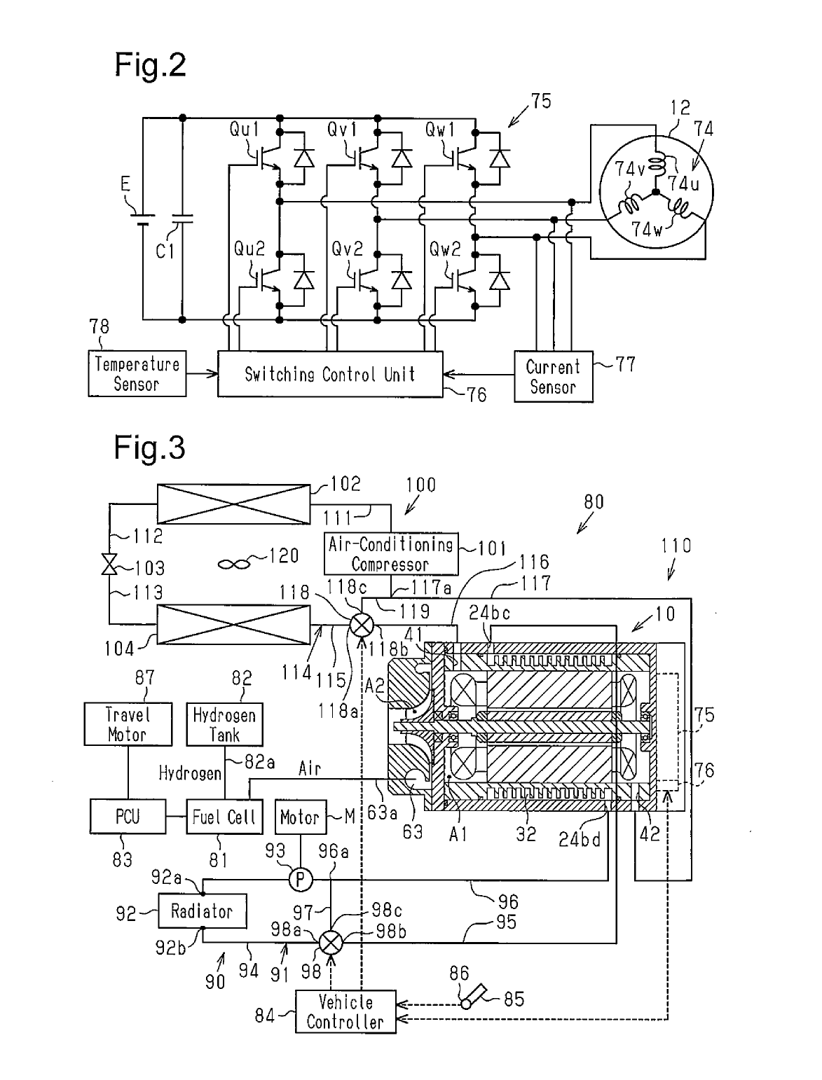

As shown in FIG. 2, the coil 74 of the electric motor 12 has, for example, a three-phase structure including a u-phase coil 74u, a v-phase coil 74v, and a w-phase coil 74w. The coils 74u to 74w are Y-connected.

The inverter 75 includes u-phase power switching elements Qu1, Qu2, which correspond to the u-phase coil 74u, v-phase power switching elements Qv1, Qv2, which correspond to the v-phase coil 74v, and w-phase power switching elements Qw1, Qw2, which correspond to the w-phase coil 74w. The power switching elements Qu1, Qu2, Qv1, Qv2, Qw1, Qw2 (hereafter simply referred to as “the power switching elements Qu1 to Qw 2”) are each, for example, an insulated gate bipolar transistor (IGBT).

The u-phase power switching elements Qu1, Qu2 are connected in series to each other by a connection wire. The connection wire is connected to the u-phase coil 74u. The series connected body of the u-phase power switching elements Qu1, Qu2 directly receives DC power from a DC power supply E. The remaining power switching elements Qv1, Qv2, Qw1, Qw2 differ from the u-phase power switching elements Qu1, Qu2 in the corresponding coil but otherwise have the same connection configuration. Thus, the connection configuration of the power switching elements Qv1, Qv2, Qw1, Qw2 will not be described in detail. The inverter 75 includes a smoothing capacitor C1, which is connected in parallel to the DC power supply E.

The inverter 75 includes a switching control unit 76, which controls switching operations of the power switching elements Qu1 to Qw2. The switching control unit 76 drives, or rotates, the electric motor 12 by cyclically activating and deactivating each of the power switching elements Qu1 to Qw2.

As shown in FIG. 2, the inverter 75 includes a current sensor 77, which detects current flowing to each of the coils 74u to 74w of the electric motor 12 and sends the detection result to the switching control unit 76. This allows the switching control unit 76 to recognize the current flowing to each of the coils 74u to 74w. The inverter 75 further includes a temperature sensor 78, which detects the temperature of each of the coils 74u to 74w of the electric motor 12 and sends the detection result to the switching control unit 76. This allows the switching control unit 76 to recognize the temperature of each of the coils 74u to 74w.

A fuel cell vehicle in which the motor-driven compressor 10 is installed will now be described.

As shown in FIG. 3, a fuel cell vehicle 80 includes a fuel cell 81, a hydrogen tank 82, which stores hydrogen that is supplied to the fuel cell 81, and the motor-driven compressor 10, which has been described. The fuel cell vehicle 80 includes a power control unit 83 (hereafter referred to as “the PCU”) and a vehicle controller 84, which controls the fuel cell vehicle 80. The PCU 83 includes a step-up converter, which increases the voltage of power from the fuel cell 81, and an inverter, which converts DC power into AC power.

The vehicle controller 84 and the switching control unit 76 may be realized by, for example, circuitry, that is, one or more dedicated hardware circuits such as ASICs, one or more processing circuits that are operated in accordance with computer programs (software), or the combination of both. A processing circuit includes a CPU and a memory (e.g., ROM and RAM), which stores programs executed by the CPU. The memory and a computer readable medium include any applicable medium that can be accessed by a general or dedicated computer.

The fuel cell vehicle 80 includes an accelerator pedal 85, which is operated by the driver, an accelerator sensor 86, which detects the operation amount of the accelerator pedal 85 and sends the detection result (i.e., accelerator position, open degree of throttle valve, or depression amount of accelerator pedal) to the vehicle controller 84, and a travel motor 87, which functions as a drive source for the fuel cell vehicle 80. The fuel cell vehicle 80 further includes a heating element cooler 90, which cools heating elements installed in the fuel cell vehicle 80, and an air conditioner 100, which adjusts, for example, the temperature and the humidity of the passenger compartment.

The hydrogen tank 82 is connected to the fuel cell 81 by a pipe 82a. The discharge chamber 63 of the motor-driven compressor 10 is connected to the fuel cell 81 by a pipe 63a. The fuel cell 81 generates power through a chemical reaction of hydrogen, which is supplied from the hydrogen tank 82, with oxygen, which is included in air supplied from the motor-driven compressor 10. The fuel cell 81 is electrically connected to the travel motor 87 by the PCU 83.

The vehicle controller 84 controls power supplied to the travel motor 87 by controlling the PCU 83 in accordance with the accelerator position. More specifically, the vehicle controller 84 calculates power needed by the travel motor 87 based on the accelerator position and controls the PCU 83 in accordance with the calculation. Thus, the travel motor 87 is driven when powered by the fuel cell 81. The power generated by the travel motor 87 is transmitted to the axle by a power transmission mechanism (not shown). Accordingly, the fuel cell vehicle 80 travels at a vehicle speed corresponding to the accelerator position.

The vehicle controller 84 is connected to the switching control unit 76 and capable of recognizing the current flowing to each of the coils 74u to 74w and the temperature of each of the coils 74u to 74w through the switching control unit 76.

To ensure the responsiveness of the fuel cell vehicle 80 to a change in the accelerator position (i.e., acceleration performance), the fuel cell 81 needs to immediately generate power corresponding to the power needed by the travel motor 87. Because air is necessary for the power generation of the fuel cell 81, the motor-driven compressor 10 needs to immediately supply air at a flow rate corresponding to the accelerator position. In the motor-driven compressor 10, which is driven by the electric motor 12, the responsiveness to the change in the accelerator position may be improved by increasing the output of the electric motor 12. The increase in the output of the electric motor 12 increases the current flowing to the coils 74u to 74w. This increases the amount of heat generated in the electric motor 12.

The tolerable temperature is set for each member (e.g., insulation member that insulates coils 74u to 74w from one another) in the motor-driven compressor 10. If a member having a high tolerable temperature is used in correspondence with the increase in the amount of heat generated in the coils 74u to 74w, the member may be enlarged. Enlargement of each member in the motor-driven compressor 10 may result in enlargement of the entire motor-driven compressor 10. In the present embodiment, even when the amount of heat generated in the coils 74u to 74w is increased, the electric motor 12 is cooled so that the temperature is not excessively increased in each member of the motor-driven compressor 10. Thus, the enlargement of the motor-driven compressor 10 is limited. A cooling system 110, which is installed in the fuel cell vehicle 80 to cool the electric motor 12 of the motor-driven compressor 10, will now be described.

The cooling system 110 cools the electric motor 12 of the motor-driven compressor 10 using the heating element cooler 90 and the air conditioner 100.

The heating element cooler 90 includes pipes 94, 96, 97, a radiator 92, a pump 93, and a motor M. The coolant circulates through the pipes 94, 96, 97. The radiator 92 cools the coolant using the air flow produced when the vehicle travels. The pump 93 sends the coolant to the pipes 94, 96, 97. The motor M functions as a drive source for the pump 93. The coolant, which is, for example, antifreeze, exchanges heat with heating elements. The heating elements are installed in the fuel cell vehicle 80 and generate heat when the fuel cell vehicle 80 travels. Examples of the heating elements include the travel motor 87, the PCU 83, and the fuel cell 81.

The air conditioner 100 includes an air-conditioning compressor 101, which compresses and discharges an air-conditioning refrigerant (e.g., chlorofluorocarbon gas), a capacitor 102 (heat exchanger), which cools the air-conditioning refrigerant, an expansion valve 103, which reduces the pressure of the air-conditioning refrigerant, and an evaporator 104, which vaporizes the air-conditioning refrigerant. The air conditioner 100 further includes pipes 111, 112, 113, 115, 117, 119, through which the air-conditioning refrigerant flows.

The cooling system 110 includes a passage connection pipe 91, which connects the radiator 92 and the third jacket through hole 24bc of the motor-driven compressor 10, and a first switching valve 98, which functions as a coolant flow switching portion that switches between states allowing and prohibiting the flow of the coolant to the passage 32 through the passage connection pipe 91. The cooling system 110 includes a coolant outlet pipe 96, which connects the fourth jacket through hole 24bd of the motor-driven compressor 10 and the radiator 92. The cooling system 110 includes an inlet pipe 114, which connects the evaporator 104 and the inlet 41 of the motor-driven compressor 10, and an outlet pipe 117, which connects the outlet 42 of the motor-driven compressor 10 and the air-conditioning compressor 101. The cooling system 110 includes a second switching valve 118, which functions as a switching portion that switches between states allowing and prohibiting the flow of the air-conditioning refrigerant to the motor chamber A1 through the inlet pipe 114 after the air-conditioning refrigerant passes through the evaporator 104 and before the air-conditioning refrigerant reaches the air-conditioning compressor 101. Additionally, the cooling system 110 includes the vehicle controller 84, which controls the first switching valve 98 and the second switching valve 118.

The radiator 92 includes an intake port 92a, which draws the coolant into the radiator 92, and a coolant discharge port 92b, which discharges the coolant out of the radiator 92 after the coolant passes through the radiator 92.

The first switching valve 98 includes a supply port 98a, through which the coolant is supplied, and two discharge ports 98b, 98c, which discharge the coolant supplied from the supply port 98a. In the present embodiment, the first switching valve 98 is controlled by the vehicle controller 84 to discharge the coolant, which is supplied from the supply port 98a, from a first discharge port 98b or a second discharge port 98c.

The passage connection pipe 91 includes a first coolant pipe 94 and a second coolant pipe 95. The first coolant pipe 94 has a first end, which is connected to the coolant discharge port 92b of the radiator 92. The first coolant pipe 94 has a second end, which is connected to the supply port 98a of the first switching valve 98. The second coolant pipe 95 has a first end, which is connected to the first discharge port 98b of the first switching valve 98. The second coolant pipe 95 has a second end, which is connected to the third jacket through hole 24bc of the motor-driven compressor 10. The coolant outlet pipe 96 has a first end, which is connected to the fourth jacket through hole 24bd of the motor-driven compressor 10. The coolant outlet pipe 96 has a second end, which is connected to the intake port 92a of the radiator 92. This obtains a first circulation path in which the coolant sequentially circulates through the radiator 92, the first coolant pipe 94, the second coolant pipe 95, the passage 32, the coolant outlet pipe 96, and the radiator 92. The first circulation path circulates the coolant for the purpose of cooling the electric motor 12. When the coolant flows through the passage 32, the electric motor 12 is cooled by the side wall 21a of the motor housing 21. The cooling system 110, which cools the electric motor 12, includes the pipes 94, 95, which send the coolant from the radiator 92 to the passage 32, and the coolant outlet pipe 96, which sends the coolant from the passage 32 to the radiator 92.

The heating element cooler 90 includes a bypass pipe 97, which connects the first coolant pipe 94 and the coolant outlet pipe 96 without connecting the passage 32. The coolant outlet pipe 96 includes a connection port 96a, which is connected to the bypass pipe 97 between the first end and the second end. The bypass pipe 97 has a first end, which is connected to the second discharge port 98c of the first switching valve 98. The bypass pipe 97 has a second end, which is connected to the connection port 96a of the coolant outlet pipe 96. This obtains a second circulation path in which the coolant sequentially circulates through the radiator 92, the first coolant pipe 94, the bypass pipe 97, the coolant outlet pipe 96, and the radiator 92. The second circulation path, which circulates the coolant for the purpose of cooling the heating elements, allows only the heating elements to be cooled without sending the coolant to the passage 32. The heating element cooler 90, which cools the heating elements, includes the pipes 94, 96, 97, which allow for circulation of the coolant without sending the coolant to the passage 32.

The heating element cooler 90 and the cooling system 110 share the first coolant pipe 94 and the coolant outlet pipe 96.

The second switching valve 118 includes a supply port 118a, through which the air-conditioning refrigerant is supplied, and two discharge ports 118b, 118c, which discharge the air-conditioning refrigerant supplied from the supply port 118a. In the present embodiment, the second switching valve 118 is controlled by the vehicle controller 84 to discharge the air-conditioning refrigerant, which is supplied from the supply port 118a, from a first discharge port 118b or a second discharge port 118c.

A first pipe 111 has a first end, which is connected to the air-conditioning compressor 101. The first pipe 111 has a second end, which is connected to the capacitor 102. A second pipe 112 has a first end, which is connected to the capacitor 102. The second pipe 112 has a second end, which is connected to the expansion valve 103. A third pipe 113 has a first end, which is connected to the expansion valve 103. The third pipe 113 has a second end, which is connected to the evaporator 104.

The inlet pipe 114 includes a first refrigerant pipe 115 and a second refrigerant pipe 116. The first refrigerant pipe 115 has a first end, which is connected to the evaporator 104. The first refrigerant pipe 115 has a second end, which is connected to the supply port 118a of the second switching valve 118. The second refrigerant pipe 116 has a first end, which is connected to the first discharge port 118b of the second switching valve 118. The second refrigerant pipe 116 has a second end, which is connected to the inlet 41 of the motor-driven compressor 10. The outlet pipe 117 has a first end, which is connected to the outlet 42 of the motor-driven compressor 10. The outlet pipe 117 has a second end, which is connected to the air-conditioning compressor 101. This obtains a first refrigerant circulation path in which the air-conditioning refrigerant sequentially circulates through the air-conditioning compressor 101, the first pipe 111, the capacitor 102, the second pipe 112, the expansion valve 103, the third pipe 113, the evaporator 104, the first refrigerant pipe 115, the second refrigerant pipe 116, the motor chamber A1, the outlet pipe 117, and the air-conditioning compressor 101. The first refrigerant circulation path circulates the air-conditioning refrigerant for the purpose of cooling the electric motor 12. When the air-conditioning refrigerant flows to the motor chamber A1, the electric motor 12 is cooled. The cooling system 110, which cools the electric motor 12, includes the pipes 115, 116, which send the air-conditioning refrigerant that has passed through the evaporator 104 to the motor chamber A1, and the outlet pipe 117, which sends the air-conditioning refrigerant that is discharged from the motor chamber A1 to the air-conditioning compressor 101.

The air conditioner 100 includes a connection pipe 119, which connects the evaporator 104 and the air-conditioning compressor 101 without connecting the motor chamber A1. The outlet pipe 117 includes a connection port 117a, which is connected to the connection pipe 119 between the first end and the second end. The connection pipe 119 has a first end, which is connected to the second discharge port 118c of the second switching valve 118. The connection pipe 119 has a second end, which is connected to the connection port 117a. This obtains a second refrigerant circulation path in which the air-conditioning refrigerant sequentially circulates through the air-conditioning compressor 101, the first pipe 111, the capacitor 102, the second pipe 112, the expansion valve 103, the third pipe 113, the evaporator 104, the first refrigerant pipe 115, the connection pipe 119, the outlet pipe 117, and the air-conditioning compressor 101. The second refrigerant circulation path, which circulates the air-conditioning refrigerant for the purpose of air-conditioning of the passenger compartment, circulates the air-conditioning refrigerant without sending the air-conditioning refrigerant to the motor chamber A1. The air conditioner 100 includes the pipes 115, 117, which send the air-conditioning refrigerant to the air-conditioning compressor 101 after the air-conditioning refrigerant passes through the evaporator 104 without sending the air-conditioning refrigerant to the motor chamber A1.

The air conditioner 100 and the cooling system 110 share the first refrigerant pipe 115 and the outlet pipe 117.

The air-conditioning compressor 101, which is of a motor-driven type and driven by an electric motor, compresses a gas-state air-conditioning refrigerant to increase the pressure and temperature of the air-conditioning refrigerant. The air-conditioning compressor 101 sends the air-conditioning refrigerant to the capacitor 102. The air-conditioning refrigerant, which is sent to the capacitor 102 from the air-conditioning compressor 101, is cooled to change into a liquid state. The air surrounding the capacitor 102 is warmed by exchanging heat with the air-conditioning refrigerant through the capacitor 102.

The air-conditioning refrigerant, which was changed to the liquid state in the capacitor 102, is ejected by the expansion valve 103 so that the air-conditioning refrigerant is changed into a spray state and easily vaporized. The air-conditioning refrigerant is vaporized in the evaporator 104. The evaporator 104 is cooled by vaporization heat. This cools the air surrounding the evaporator 104.

The air conditioner 100 includes an air blower 120. The air conditioner 100 is capable of warming the passenger compartment by sending air that is warmed by the capacitor 102 to the passenger compartment through the air blower 120. Also, the air conditioner 100 is capable of cooling the passenger compartment by sending air that is cooled by the evaporator 104 to the passenger compartment through the air blower 120. The air-conditioning refrigerant evaporated in the evaporator 104 flows to the second switching valve 118 through the first refrigerant pipe 115 and then to the second refrigerant pipe 116 or the connection pipe 119 through the second switching valve 118. After flowing through the second refrigerant pipe 116 or the connection pipe 119, the air-conditioning refrigerant flows through the outlet pipe 117 and returns to the air-conditioning compressor 101. The air-conditioning compressor 101 again increases the temperature and pressure of the air-conditioning refrigerant.

When the air-conditioning refrigerant evaporated in the evaporator 104 returns to the air-conditioning compressor 101 through the second refrigerant pipe 116, the air-conditioning refrigerant flows through the motor chamber A1 from the inlet 41 toward the outlet 42.

When the air-conditioning refrigerant that has passed through the evaporator 104 but has not reached the air-conditioning compressor 101 is referred to as a low-temperature refrigerant, the low-temperature refrigerant has been evaporated in the evaporator 104 and thus is in a gas state. Additionally, the temperature of the low-temperature refrigerant is low to cool the passenger compartment. When the low-temperature refrigerant flows through the motor chamber A1, the low-temperature refrigerant exchanges heat with the electric motor 12 (coils 74u to 74w). This cools the electric motor 12. After flowing through, for example, a gap between the rotor 71 and the stator 72, in the motor chamber A1, the low-temperature refrigerant is discharged from the outlet 42 of the motor-driven compressor 10 and returned to the air-conditioning compressor 101 through the outlet pipe 117. As described above, since the low-temperature refrigerant is in a gas state when flowing through the motor chamber A1, the resistance caused by agitation is small and subtly affects the rotation of the rotation shaft 11.

When the coolant flows through the passage 32, the coolant indirectly exchanges heat with the electric motor 12 by exchanging heat with the motor housing 21. The low-temperature refrigerant, the temperature of which is low due to the evaporation in the evaporator 104, directly exchanges heat with the electric motor 12 by flowing through the motor chamber A1. Thus, when the low-temperature refrigerant flows to the motor chamber A1, heat is moved to the fluid from the electric motor 12 by a greater amount than when the coolant flows to the passage 32.

As described above, the coolant, which is used in the heating element cooler 90, and the air-conditioning refrigerant, which is used in the air conditioner 100, are used as fluids for cooling the motor-driven compressor 10 to cool the electric motor 12 (coils 74u to 74w).

When the electric motor 12 is cooled by sending the coolant, which is used in the heating element cooler 90, to the passage 32, power is consumed to drive the motor M. When the electric motor 12 is cooled by sending the air-conditioning refrigerant, which is used in the air conditioner 100, to the motor chamber A1, power is consumed to drive the air-conditioning compressor 101 (more specifically, electric motor of air-conditioning compressor 101).

The power consumed to drive the air-conditioning compressor 101 is larger than the power consumed to drive the motor M. However, the cooling performance of the low-temperature refrigerant flowing to the motor chamber A1 is higher than the cooling performance of the coolant flowing to the passage 32. That is, when the low-temperature refrigerant flows to the motor chamber A1 to cool the electric motor 12, the cooling effect is high but the power consumption is large. When the coolant flows to the passage 32 to cool the electric motor 12, the cooling effect is low but the power consumption is small. Additionally, the efficiency for exchanging heat between the fluid and the electric motor 12 (cooling efficiency) relative to the power consumption is higher when the coolant flows to the passage 32.

In the present embodiment, the electric motor 12 is cooled by the low-temperature refrigerant only in a high load state, in which the temperature of the electric motor 12 tends to increase as compared to in a low load state. In the low load state, the electric motor 12 is cooled by the coolant. This reduces power consumption. The high load state is, for example, when the vehicle is traveling with high speed or on an uphill.

The control performed by the vehicle controller 84 will now be described together with the operation of the motor-driven compressor 10 and the cooling system 110.

The vehicle controller 84 monitors the current flowing to each of the coils 74u to 74w of the electric motor 12 and determines whether the load is high or low from the current flowing to the coils 74u to 74w of the electric motor 12. More specifically, a condition in which the temperature of the coils 74u to 74w tends to increase is determined based on at least one of the current flowing to the coils 74u to 74w, the temperature of the coils 74u to 74w, and the traveling state of the fuel cell vehicle 80. When the condition is satisfied, the vehicle controller 84 determines that the load is high. In the present embodiment, the condition is determined based on the current flowing to the coils 74u to 74w. The vehicle controller 84 determines that the load is high when a current condition is satisfied. The current condition is satisfied when the current is greater than a predetermined current threshold value. The vehicle controller 84 determines that the load is low when the current condition is not satisfied. The current threshold value is a value of current flowing to the coils 74u to 74w of the electric motor 12 when the load is high and obtained through tests or simulations. In the high load state, the temperature of the coils 74u to 74w has a tendency to increase. In such a situation, the temperature of the electric motor 12 may reach the tolerable temperature limit of each member in the motor-driven compressor 10 unless the electric motor 12 is cooled by the low-temperature refrigerant. When the current condition is satisfied, the vehicle controller 84 determines that the temperature of the electric motor 12 has a tendency to increase and cools the electric motor 12 using the low-temperature refrigerant. This prevents the temperature of the electric motor 12 from reaching the tolerable temperature limit.

When the current condition is satisfied, that is, when the current flowing to the coils 74u to 74w is greater than the current threshold value, the vehicle controller 84 cools the electric motor 12 using the low-temperature refrigerant. Additionally, the vehicle controller 84 cools the electric motor 12 using the coolant when a coolant flow current condition is satisfied. The coolant flow current condition is satisfied that the current flowing to the coils 74u to 74w is less than or equal to a predetermined coolant flow current threshold value. Thus, the vehicle controller 84 functions as a control portion and a coolant control portion. In the present embodiment, the current threshold value and the coolant flow current threshold value are set to be the same value. Thus, when one of the current condition and the coolant flow current condition is satisfied, the other is unsatisfied. More specifically, the cooling system 110 of the present embodiment does not simultaneously cool the electric motor 12 using the coolant and the low-temperature refrigerant and thus performs the cooling using only one of the coolant and the low-temperature refrigerant.

When the current is less than or equal to the predetermined coolant flow current threshold value (i.e., when the coolant flow current condition is satisfied and the current condition is unsatisfied), the vehicle controller 84 controls the first switching valve 98 so that the coolant is discharged from the first discharge port 98b and sent to the second coolant pipe 95. The vehicle controller 84 controls the second switching valve 118 so that the low-temperature refrigerant is discharged from the second discharge port 118c and sent to the connection pipe 119. Additionally, when the pump 93 is not driven, the vehicle controller 84 drives the pump 93. Consequently, in the low load state, which does not need the high cooling effect, while the coolant flows to the water jacket 24, the low-temperature refrigerant does not flow to the motor chamber A1.

When the current is greater than the predetermined current threshold value (i.e., when the current condition is satisfied and the coolant flow current condition is unsatisfied), the vehicle controller 84 controls the first switching valve 98 so that the coolant is discharged from the second discharge port 98c and sent to the bypass pipe 97. The vehicle controller 84 controls the second switching valve 118 so that the low-temperature refrigerant is discharged from the first discharge port 118b and sent to the second refrigerant pipe 116. Additionally, when the air-conditioning compressor 101 is not driven, that is, when the air-conditioning of the passenger compartment is not performed, the vehicle controller 84 drives the air-conditioning compressor 101. In this case, the vehicle controller 84 does not drive the air blower 120, which sends the air surrounding the capacitor 102 or the evaporator 104 to the passenger compartment. This prevents cooled or warmed air from being sent to the passenger compartment. Consequently, in the high load state, which needs the high cooling effect, while the coolant does not flow to the water jacket 24, the low-temperature refrigerant flows to the motor chamber A1.

Accordingly, the above embodiment has the advantages described below.

(1) The housing 20 of the motor-driven compressor 10 includes the motor chamber A1 and the compression chamber A2, which are separated from each other. The seal member 53 restricts the flow of the fluids between the motor chamber A1 and the compression chamber A2. This allows different kinds of fluids to flow to the motor chamber A1 and the compression chamber A2. The housing 20 includes the inlet 41, which draws the low-temperature refrigerant used in the air conditioner 100 to the motor chamber A1, and the outlet 42, which discharges the low-temperature refrigerant from the motor chamber A1. This allows the low-temperature refrigerant used in the air conditioner 100 to flow to the motor chamber A1. When the low-temperature refrigerant flows to the motor chamber A1, the electric motor 12 directly exchanges heat with the low-temperature refrigerant. Thus, the temperature of the motor-driven compressor 10 is hindered from increasing even when the amount of heat generated in the coils 74u to 74w is increased due to increases in the output of the electric motor 12. This limits enlargement of the motor-driven compressor 10 to increase the tolerable temperature of each member in the motor-driven compressor 10.

(2) A motor-driven compressor that supplies air to the fuel cell may include a motor chamber and a compression chamber that are in communication with each other. In such a type of motor-driven compressor, the housing includes an air suction port, which draws air into the motor chamber. The air is drawn from the air suction port into the motor chamber and then sent from the motor chamber to the compression chamber, in which the air is compressed. More specifically, the same fluid (air) flows to the motor chamber and the compression chamber. In this case, when the air flows through the motor chamber, the electric motor is cooled through a heat exchange between the electric motor and the air.

However, since a motor-driven compressor installed in a fuel cell vehicle compresses air, the cooling effect on the electric motor depends on the temperature of the air (ambient temperature). The ambient temperature is likely to be higher than the low-temperature refrigerant except a particular circumstance such as a winter season or a cold region. Hence, when the electric motor is cooled by the air, a sufficient cooling effect may not be always ensured. Additionally, because the ambient temperature changes depending on seasons and weather, it is difficult to stably cool the electric motor. In this regard, the present embodiment uses the low-temperature refrigerant. Thus, in the high load state, the cooling effect on the electric motor is high regardless of season, location, and weather.

(3) The motor-driven compressor 10 includes the water jacket 24. The water jacket 24 covers the side wall 21a of the motor housing 21 from a radially outer side. Thus, the water jacket 24 includes the jacket side wall 24b defining the passage 32. The electric motor 12 is cooled when the coolant flows to the passage 32.

(4) The inlet 41 includes the first wall through hole 21aa and the first jacket through hole 24ba. The outlet 42 includes the second wall through hole 21ab and the second jacket through hole 24bb. This allows the low-temperature refrigerant to flow to the motor chamber A1 even when the side wall 21a of the motor housing 21 is covered by the jacket side wall 24b of the water jacket 24.

(5) The seal member 53 restricts the flow of fluids through the through hole 23a. This limits communication of the fluids between the motor chamber A1 and the compression chamber A2 through the through hole 23a even when the motor chamber A1 and the compression chamber A2 are separated by the separation wall 23 having the through hole 23a.

(6) The cooling system 110 includes the second switching valve 118, which switches between the states allowing and prohibiting the flow of the low-temperature refrigerant to the motor chamber A1. Thus, when the electric motor 12 does not need to be cooled by the low-temperature refrigerant, the low-temperature refrigerant does not have to be sent to the motor chamber A1. The low-temperature refrigerant has the high cooling effect on the electric motor 12 but consumes large power. When the electric motor 12 does not need to be cooled by the low-temperature refrigerant, the air-conditioning compressor 101 does not have to be driven to obtain the low-temperature refrigerant. This reduces power consumption as compared to when the air-conditioning compressor 101 is constantly driven.

(7) The low-temperature refrigerant is sent to the motor chamber A1 only when the current flowing to each of the coils 74u to 74w is greater than the predetermined current threshold value (i.e., when the current condition is satisfied). This reduces power consumption.

(8) The cooling system 110 includes the first switching valve 98, which switches between the states allowing and prohibiting the flow of the coolant to the passage 32. Thus, the electric motor 12 is cooled by the coolant as necessary.

(9) When the coolant flow current condition is satisfied, the coolant is sent to the passage 32. Thus, whether or not to cool the electric motor 12 using the coolant may be determined in accordance with the amount of heat generated in the electric motor 12.

(10) The electric motor 12 is cooled by the low-temperature refrigerant when the current flowing to the coils 74u to 74w is greater than the current threshold value, and by the coolant when the current flowing to the coils 74u to 74w is less than or equal to the coolant flow current threshold value. Different cooling modes are used in accordance with the amount of heat generated in the electric motor 12. This limits insufficiency of the cooling effect while reducing power consumption.

The above embodiment may be modified as follows.

The coolant flow current threshold value and the current threshold value may set to be different values. In this case, if the coolant flow current threshold value is set to be greater than the current threshold value, when the current flowing to the coils 74u to 74w is greater than the current threshold value and less than or equal to the coolant flow current threshold value, the electric motor 12 is cooled by both of the coolant and the low-temperature refrigerant.

When the current threshold value and the coolant flow current threshold value are set to be the same value, the electric motor 12 may temporarily not be cooled by either of the coolant and the low-temperature refrigerant due to, for example, a response delay when switching the coolant and the low-temperature refrigerant to cool the electric motor 12. In this regard, when the coolant flow current threshold value is set to be greater than the current threshold value, the current condition and the coolant flow current condition may be simultaneously satisfied. This limits situations in which the electric motor 12 is not cooled by either of the coolant and the low-temperature refrigerant when switching the coolant and the low-temperature refrigerant to cool the electric motor 12.

In addition to the time of switching the coolant and the low-temperature refrigerant to cool the electric motor 12, the electric motor 12 may be simultaneously cooled by the coolant and the low-temperature refrigerant, for example, in the high load state.

The condition for cooling the electric motor 12 with the low-temperature refrigerant, that is, the condition in which the temperature of the coils 74u to 74w tends to increase, may be determined based on the temperature of the coils 74u to 74w that is detected by the temperature sensor 78. The vehicle controller 84 monitors the temperature of the coils 74u to 74w and cools the electric motor 12 using the low-temperature refrigerant when a temperature condition is satisfied. The temperature condition is satisfied when the temperature of the coils 74u to 74w is greater than a predetermined temperature threshold value. Also, the vehicle controller 84 may cool the electric motor 12 using the coolant when a coolant flow temperature condition is satisfied. The coolant flow temperature condition is satisfied when the temperature of the coils 74u to 74w is less than or equal to a predetermined coolant flow temperature threshold value. The coolant flow temperature threshold value is set to be, for example, greater than or equal to the temperature threshold value.

The vehicle controller 84 may cool the electric motor 12 using the coolant when at least one of the coolant flow current condition and the coolant flow temperature condition is satisfied.

The condition in which the temperature of the coils 74u to 74w tends to increase may be determined based on the traveling state of the fuel cell vehicle 80. Whether or not to cool the electric motor 12 using the low-temperature refrigerant may be determined, for example, based on the relationship between the accelerator position and the actual vehicle speed. For example, in a high load state such as when the vehicle is traveling on an uphill, the actual vehicle speed is hindered from increasing with respect to the accelerator position. Thus, the relationship between the accelerator position and the actual vehicle speed allows for the assumption of whether or not the load on the electric motor 12, that is, the temperature of the coils 74u to 74w, has a tendency to increase. When the accelerator position and the actual vehicle speed have a certain relationship, the temperature of the coils 74u to 74w increases to the tolerable temperature limit of each member in the motor-driven compressor 10 unless the motor-driven compressor 10 is cooled by the low-temperature refrigerant. This relationship is obtained in advance and set as the condition that increases the temperature of the coils 74u to 74w. Then, when the condition is satisfied, the temperature of the coils 74u to 74w is determined to have a tendency to increase and the electric motor 12 is cooled by the low-temperature refrigerant. Additionally, when the actual vehicle speed is continuously high, the electric motor 12 may be cooled by the low-temperature refrigerant. In this case, when the actual vehicle speed is continuously high for longer than a predetermined threshold time, the temperature of the coils 74u to 74w is determined to have a tendency to increase and the electric motor 12 is cooled by the low-temperature refrigerant.

The condition in which the temperature of the coils 74u to 74w tends to increase may be determined based on two or more of the current flowing to the coils 74u to 74w, the temperature of the coils 74u to 74w, and the traveling state of the fuel cell vehicle 80. The vehicle controller 84 monitors, for example, the current flowing to the coils 74u to 74w and the temperature of the coils 74u to 74w. When at least one of the current condition and the temperature condition is satisfied, the electric motor 12 may be cooled by the low-temperature refrigerant. Alternatively, when at least one of the current condition, the temperature condition, and the condition determined based on the traveling state is satisfied, the vehicle controller 84 may cool the electric motor 12 using the low-temperature refrigerant. Alternatively, when at least two of the above conditions are satisfied, the vehicle controller 84 may cool the electric motor 12 using the low-temperature refrigerant. Further, only when all of the above three conditions are satisfied, the vehicle controller 84 may cool the electric motor 12 using the low-temperature refrigerant.

The coolant used in the heating element cooler 90 flows to the water jacket 24. Instead, a dedicated device for sending a coolant to the water jacket 24 may be used.

The water jacket 24 may be omitted from the housing 20 of the motor-driven compressor 10. In this case, when the condition for cooling the electric motor 12 with the low-temperature refrigerant is not satisfied, the electric motor 12 is not cooled. When the condition for cooling the electric motor 12 with the low-temperature refrigerant is satisfied, the electric motor 12 is cooled by the low-temperature refrigerant. Additionally, if the housing 20 (side wall 21a of housing 20) includes a passage that allows for the flow of fluids such as the air-conditioning refrigerant and the coolant, the housing 20 may be enlarged to ensure that the side wall 21a is thick enough to withstand the pressure of the refrigerant flowing through the passage. In this regard, the low-temperature refrigerant flows to the motor chamber A1 so that the side wall 21a of the housing 20 does not include a passage through which a fluid flows. This limits enlargement of the housing 20.

When the housing 20 does not include the water jacket 24 or when the housing 20 includes the inlet and the outlet at positions that are not covered by the water jacket 24, the inlet and the outlet may each be a single through hole in a partition wall defining the motor chamber A1.

The positional relationship between the inlet 41 and the outlet 42 may be changed.

When the air-conditioning of the passenger compartment is activated by the driver, the low-temperature refrigerant may flow to the motor chamber A1 regardless of whether the load on the electric motor 12 is high or low.

The fins 33 may be omitted.

The vehicle controller 84 may control the fuel cell vehicle 80 by giving instructions to control portions separately arranged for the heating element cooler 90 and the air conditioner 100. More specifically, the control portions separately arranged for the heating element cooler 90 and the air conditioner 100 may function as the controller. Alternatively, the control portions and the vehicle controller 84 may function as the controller.

The motor-driven compressor may be of a scroll type. Alternatively, the motor-driven compressor may be of a Roots type.

When the jacket side wall 24b of the water jacket 24 includes a recess that extends radially outward from the inner circumferential surface, the passage 32 may be defined between the jacket side wall 24b and the side wall 21a of the motor housing 21. In this case, the coolant recess 31 may or may not be omitted.

When the electric motor 12 is cooled by the coolant, the coolant may flow to the bypass pipe 97 in addition to the passage 32. More specifically, the first switching valve 98 may be switched to discharge the coolant from both of the first discharge port 98b and the second discharge port 98c or only from the second discharge port 98c.

When the electric motor 12 is cooled by the low-temperature refrigerant, the low-temperature refrigerant may flow to the connection pipe 119 in addition to the motor chamber A1. More specifically, the second switching valve 118 may be switched to discharge the low-temperature refrigerant from both of the first discharge port 118b and the second discharge port 118c or only from the second discharge port 118c.

What is claimed is:

1. A motor-driven compressor installed in a fuel cell vehicle to supply air to a fuel cell, wherein the fuel cell vehicle includes a travel motor, the fuel cell that powers the travel motor, and an air conditioner including an evaporator and a motor-driven air-conditioning compressor that compresses an air-conditioning refrigerant, the motor driven compressor comprising:
a rotation shaft;
an electric motor that rotates the rotation shaft;
a compression unit rotated to compress air when the rotation shaft is rotated;
a housing that includes a motor chamber and a compression chamber, wherein the motor chamber accommodates the electric motor, and the compression chamber accommodates the compression unit; and
a seal member that restricts a flow of a fluid between the motor chamber and the compression chamber;
wherein the housing includes
an inlet that draws, into the motor chamber, the air-conditioning refrigerant that has passed through the evaporator but has not reached the air-conditioning compressor as a low-temperature refrigerant, and
an outlet that discharges the low-temperature refrigerant, which is drawn from the inlet into the motor chamber, out of the motor chamber.

2. The motor-driven compressor according to claim 1, wherein the housing further includes
a partition wall defining the motor chamber, and
a water jacket that at least partially covers an outer side of the partition wall to define a passage through which a coolant flows between the partition wall and the water jacket.

3. The motor-driven compressor according to claim 2, wherein
the partition wall includes a first wall through hole and a second wall through hole,
the water jacket includes a first jacket through hole, which is in communication with the first wall through hole, and a second jacket through hole, which is in communication with the second wall through hole,
the inlet includes the first wall through hole and the first jacket through hole, and
the outlet includes the second wall through hole and the second jacket through hole.

4. The motor-driven compressor according to claim 1, wherein the housing includes a separation wall that separates the motor chamber and the compression chamber and includes a through hole through which the rotation shaft is inserted.

5. A cooling system installed in a fuel cell vehicle to cool an electric motor arranged in a motor-driven compressor, wherein the fuel cell vehicle includes a travel motor, a fuel cell that powers the travel motor, an air conditioner including an evaporator and a motor-driven air-conditioning compressor that compresses an air-conditioning refrigerant, and the motor-driven compressor that supplies air to the fuel cell, the cooling system comprising:
a rotation shaft;
the electric motor that rotates the rotation shaft;
a compression unit rotated to compress air when the rotation shaft is rotated;
a housing that includes a motor chamber and a compression chamber, wherein the motor chamber accommodates the electric motor, and the compression chamber accommodates the compression unit; and
a seal member that restricts a flow of a fluid between the motor chamber and the compression chamber;
wherein the housing includes
an inlet that draws, into the motor chamber, the air-conditioning refrigerant that has passed through the evaporator but has not reached the air-conditioning compressor as a low-temperature refrigerant, and
an outlet that discharges the low-temperature refrigerant, which is drawn from the inlet into the motor chamber, out of the motor chamber;
the cooling system further comprises:
an inlet pipe that connects the evaporator and the inlet;
an outlet pipe that connects the outlet and the air-conditioning compressor; and
a switching portion that switches between a state allowing the low-temperature refrigerant to flow to the inlet through the inlet pipe and a state prohibiting the low-temperature refrigerant from flowing to the inlet through the inlet pipe.

6. The cooling system according to claim 5, wherein
the electric motor includes a stator core and a coil wound around the stator core, and
the cooling system further comprises a control portion that controls the switching portion so that the low-temperature refrigerant flows to the inlet through the inlet pipe when a condition in which a temperature of the coil tends to increase is satisfied, wherein the condition is determined based on at least one of a current flowing to the coil, the temperature of the coil, and a traveling state of the fuel cell vehicle.

7. The cooling system according to claim 6, wherein
the condition includes at least one of a current condition and a temperature condition,
the current condition is satisfied when the current flowing to the coil is greater than a predetermined current threshold value, and
the temperature condition is satisfied when the temperature of the coil is greater than a predetermined temperature threshold value.

8. The cooling system according to claim 5, wherein
the housing further includes
a partition wall defining the motor chamber, and
a water jacket that at least partially covers an outer side of the partition wall to define a passage through which a coolant flows between the partition wall and the water jacket,
the cooling system further comprises:
a passage connection pipe that connects the passage and a radiator installed in the fuel cell vehicle; and
a coolant flow switching portion that switches between a state allowing the coolant to flow to the passage through the passage connection pipe and a state prohibiting the coolant from flowing to the passage through the passage connection pipe.

9. The cooling system according to claim 8, wherein the partition wall includes a first wall through hole and a second wall through hole,
the water jacket includes a first jacket through hole, which is in communication with the first wall through hole, and a second jacket through hole, which is in communication with the second wall through hole,
the inlet includes the first wall through hole and the first jacket through hole, and
the outlet includes the second wall through hole and the second jacket through hole.

10. The cooling system according to claim 8, wherein
the electric motor includes a stator core and a coil wound around the stator core, and
the cooling system further comprises a coolant control portion configured to control the coolant flow switching portion so that the coolant flows to the passage through the passage connection pipe when at least one of a coolant flow current condition and a coolant flow temperature condition is satisfied, wherein
the coolant flow current condition is satisfied when a current flowing to the coil is less than or equal to a predetermined coolant flow current threshold value, and
the coolant flow temperature condition is satisfied when a temperature of the coil is less than or equal to a predetermined coolant flow temperature threshold value.
